(19) United States
(12) Patent Application Publication
(10) Pub. No.: US 2012/0002938 A1
(43) Pub. Date: Jan. 5, 2012

(54) Learned cognitive system

(76) Inventor: Alex J. Kalpaxis, Glendale, NY (US)

(21) Appl. No.: 13/232,548

(22) Filed: Sep. 14, 2011

Related U.S. Application Data
(63) Continuation of application No. 12/414,627, filed on Mar. 30, 2009, now abandoned.
(60) Provisional application No. 61/064,821, filed on Mar. 28, 2008.

(51) Int. Cl. H04N 9/80

(52) U.S. Cl. 386/239; 386/E09.011

(57) ABSTRACT

Systems, methods, and computer-program products for detection of explicit video content compare pixels of a possible explicit video content with a color histogram reference. Areas of the video content are analyzed using a feature extraction technique using a cognitive learning engine, while multiple levels of weighted classifiers are used to rank particular video content.

### CROSS-REFERENCE TO RELATED APPLICATIONS

This application is a continuation of Ser. No. 12/414,627 filed Mar. 30, 2009 which claims the benefit of Ser. No. 61/064,821, filed on Mar. 28, 2008, the contents of which are incorporated herein by reference in their entirety.

### COPYRIGHT NOTICE

Portions of the disclosure of this patent document may contain material that is subject to copyright protection. The copyright owner has no objection to the facsimile reproduction by anyone of the patent document or the patent disclosure, as it appears in the United States Patent and Trademark Office file or records, but otherwise reserves all copyright rights whatsoever.

### BACKGROUND OF THE INVENTION

### Field of the Invention

The present invention in its disclosed embodiments is related generally to cognitive learning systems, methods, and computer-program products, and more particularly to such systems, methods, and computer-program products for detecting explicit images and videos (collectively “video content”) archived or being requested from the internet.

A variety of methods have been used in the past to deter the display of explicit images from a web site. Even though a web site may be free of explicit video content, it is still possible to gain access to web sites with explicit video content when initiating requests from explicit video content free sites. Existing software products on the market attempting to filter explicit video content use, e.g., universal resource locator (URL) blocking techniques to prevent access to specific web sites that contain explicit video content. These approaches are often not very effective, because it is not possible to manually screen all the explicit video content web sites that are constantly change in their content and names on a daily basis. These software products rely on either storing a local database of explicit web site URL's, or referencing external providers of such a database on the Internet.

Another common technique used to determine if the video content is explicit or not is color histogram analysis with the specific target being skin color. Unfortunately, some of the algorithms used in color histogram analysis are quite slow and have accuracies of about 55%-60%, which is an accuracy level that is unacceptable within normal corporate compliance standards. In most corporate environments, speed is a key factor for acceptability.

It is a first object of embodiments according to the present invention to provide an accurate and computationally efficient method of detecting images and videos (collectively “video content”) that may contain explicit or unsuitable content.

It is another object of embodiments according to the present invention to include a method for detecting explicit images and videos wherein a color reference is created using an intensity profile of the image/video image frame is a set of intensity values taken from regularly spaced points along a selected line segment and/or multi-line path in an image. For any points that do not fall on the center of a pixel, the intensity values may be interpolated. The line segments may be defined by specifying their coordinates as input arguments and this algorithm may use a default nearest-neighbor interpolation.

It is yet another object of embodiments according to the present invention to provide a more accurate method of detecting explicit video content. Following the color reference analysis, a Canny edge-detection method may be used, which may employ two different thresholds in order to detect strong and weak edges, and thereafter include the weak edges in the output only if they are connected to strong edges. This approach is more noise immune and able to detect true weak edges. Once the image/video edges are determined, the feature extraction process can begin.

It is still another object of embodiments according to the present invention to provide texture analysis, which allows for the characterization of regions in video content by their texture. This texture analysis may quantify qualities in the video content such as rough, smooth, silky, or bumpy as a function of the spatial variation in pixel intensities where the roughness or bumpiness refers to variations in the intensity values, or gray levels. Further, the texture analysis may determine texture segmentation. Texture analysis thus is favored when objects in video content are more characterized by their texture than by intensity and where threshold techniques will not work.

It is a further object of embodiments according to the present invention to provide a practical method for detecting, classifying and ranking video content which are suspected as explicit.

It is yet a further object of embodiments according to the present invention to analyze large volumes of video content at speeds close to or equal to real time and filter/block these from being viewed instantly.

It is still a further object of embodiments according to the present invention to provide a multi-layered detection and classification criteria that enables a low false negative rate of between 3-5%.

Finally, It is an object of embodiments according to the present invention to provide a deployed engine feature that allows for remote execution of the explicit filter analyzer to any workstation/PC or server in an enterprise.

### SUMMARY OF THE INVENTION

These and other objects, advantages, and novel features are provided by systems, methods, and computer-program products of detection are presented wherein pixels of a possible explicit video content are compared with a color histogram reference, areas of the video content are analyzed using a feature extraction technique that utilizes a cognitive learning engine and multiple levels of weighted classifiers are used to rank particular video content.

### BRIEF DESCRIPTION OF THE DRAWINGS

The foregoing and other features of the present invention will become more apparent from the following description of exemplary embodiments, as illustrated in the accompanying drawings wherein like reference numbers generally indicate identical, functionally similar, and/or structurally similar elements. Usually, the left most digit in the corresponding reference number will indicate the drawing in which an element first appears.

FIG. 1 illustrates a learned cognitive system according to a first embodiment of the present invention;

FIG. 2 illustrates the video content analysis engine of the learned cognitive system shown in FIG. 1;

FIG. 3 illustrates a learned cognitive system according to a second embodiment of the present invention;

FIG. 4 illustrates a block diagram of the video content analysis engines shown in FIGS. 1-3; and

FIG. 5 illustrates a flowchart of the methods employed in the video content analysis engines shown in FIGS. 1-4.

### DETAILED DESCRIPTION OF THE EMBODIMENTS

Exemplary embodiments are discussed in detail below. While specific exemplary embodiments are discussed, it should be understood that this is done for illustration purposes only. In describing and illustrating the exemplary embodiments, specific terminology is employed for the sake of clarity. However, the embodiments are not intended to be limited to the specific terminology so selected. Persons of ordinary skill in the relevant art will recognize that other components and configurations may be used without departing from the true spirit and scope of the embodiments. It is to be understood that each specific element includes all technical equivalents that operate in a similar manner to accomplish a similar purpose. Therefore, the examples and embodiments described herein are non-limiting examples.

Computers and other digital devices often work together in “networks.” A network is a group of two or more digital devices linked together (e.g., a computer network). There are many types of computer networks, including: local-area networks (LANs), where the computers are geographically close together (e.g., in the same building); and wide-area networks (WANs), where the computers are farther apart and are connected by telephone lines, fiber-optic cable, radio waves and the like.

In addition to the above types of networks, certain characteristics of topology, protocol, and architecture are also used to categorize different types of networks. Topology refers to the geometric arrangement of a computer system. Common topologies include a bus, mesh, ring, and star. Protocol defines a common set of rules and signals that computers on a network use to communicate. One of the most popular protocols for LANs is called Ethernet. Another popular LAN protocol for personal computers is the IBM token-ring network. Architecture generally refers to a system design. Networks today are often broadly classified as using either a client/server architecture or a peer-to-peer architecture.

The client/server model is an architecture that divides processing between clients and servers that can run on the same computer or, more commonly, on different computers on the same network. It is a major element of modern operating system and network design.

A server may be a program, or the computer on which that program runs, that provides a specific kind of service to clients. A major feature of servers is that they can provide their services to large numbers of clients simultaneously. A server may thus be a computer or device on a network that manages network resources (e.g., a file server, a print server, a network server, or a database server. For example, a file server is a computer and storage device dedicated to storing files. Any user on the network can store files on the server. A print server is a computer that manages one or more printers, and a network server is a computer that manages network traffic. A database server is a computer system that processes database queries.

Servers are often dedicated, meaning that they perform no other tasks besides their server tasks. On multi-processing operating systems, however, a single computer can execute several programs at once. A server in this case could refer to the program that is managing resources rather than the entire computer.

The client is usually a program that provides the user interface, also referred to as the front end, typically a graphical user interface or “GUI”, and performs some or all of the processing on requests it makes to the server, which maintains the data and processes the requests.

The client/server model has some important advantages that have resulted in it becoming the dominant type of network architecture. One advantage is that it is highly efficient in that it allows many users at dispersed locations to share resources, such as a web site, a database, files or a printer. Another advantage is that it is highly scalable, from a single computer to thousands of computers.

An example is a web server, which stores files related to web sites and serves (i.e., sends) them across the Internet to clients (e.g., web browsers) when requested by users. By far the most popular web server is Apache, which is claimed by many to host more than two-thirds of all web sites on the Internet.

The X Window System, thought by many to be the dominant system for managing GUIs on Linux and other Unix-like operating systems, is unusual in that the server resides on a local computer (i.e., on the computer used directly by the human user) instead of on a remote machine (i.e., a separate computer anywhere on the network), while the client can be on either the local machine or a remote machine. However, as is usually true with the client/server model, the ordinary human user does not interact directly with the server, but in this case interacts directly with the desktop environments (e.g., KDE and Gnome) that run on top of the X server and other clients.

The client/server model is most often referred to as a two-tiered architecture. Three-tiered architectures, which are widely employed by enterprises and other large organizations, add an additional layer, known as a database server. Even more complex multi-tier architectures can be designed which include additional distinct services.

Others network models include master/slave and peer-to-peer. In the former, one program is in charge of all the other programs. In the latter, each instance of a program is both a client and a server, and each has equivalent functionality and responsibilities, including the ability to initiate transactions. That is, peer-to-peer architectures involve networks in which each workstation has equivalent capabilities and responsibilities. This differs from client/server architectures, in which some computers are dedicated to serving the others. Peer-to-peer networks are generally simpler and less expensive, but they usually do not offer the same performance under heavy loads.

Computers and other digital devices on networks are sometimes also called nodes. Each node has a unique network address, and comprises a processing location.

The term “user” as used herein may typically refer to a person (i.e., a human being) using a computer or other digital device on the network. However, since the verb “use” is ordinarily defined (see, e.g., Webster's Ninth New Collegiate Dictionary 1299 (1985)) as “to put into action or service, avail oneself of, employ,” clients and servers in networks according to known client/server architectures, peers in networks according to known peer-to-peer architectures, and nodes in general may without human intervention also “put into action or service, avail themselves of, and employ” methods according to embodiments of the present invention.

Without manifestly excluding or restricting the broadest definitional scope entitled to such terms, the following are non-limiting examples of a “user,” which will be readily apparent to those of ordinary skill in the art and are intended to illustrate no clear disavowal of their ordinary meaning: a person (i.e., a human being) using a computer or other digital device, in a standalone environment or on the network; a client installed within a computer or digital device on the network, a server installed within a computer or digital device on the network, or a node installed within a computer or digital device on the network.

In the following description and claims, the terms “append”, “attach”, “couple” and “connect,” along with their derivatives, may also be used. It should be readily appreciated to those of ordinary skill in the art that these terms are not intended as synonyms for each other. Rather, in particular embodiments, “append” may be used to indicate the addition of one element as a supplement to another element, whether physically or logically. “Attach” may mean that two or more elements are in direct physical contact. However, “attach” may also mean that two or more elements are not in direct contact with each other, but may associate especially as a property or an attribute of each other.

In particular embodiments, “connected” may be used to indicate that two or more elements are in direct physical or electrical contact with each other. “Coupled” may likewise mean that two or more elements are in direct physical or electrical contact. However, “coupled” may also mean that two or more elements are not in direct contact with each other, yet still cooperate or interact with each other.

As used herein, “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with Internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

As used herein, “software” may refer to prescribed rules to operate a computer. Examples of software may include: code segments in one or more computer-readable languages; graphical and or/textual instructions; applets; pre-compiled code; interpreted code; compiled code; and computer programs.

As used herein, a “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

As used herein, a “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

As used herein, a “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: the Internet; an intranet; a local area network (LAN); a wide area network (WAN); and a combination of networks, such as an internet and an intranet. Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As used herein and generally, an “algorithm” is considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

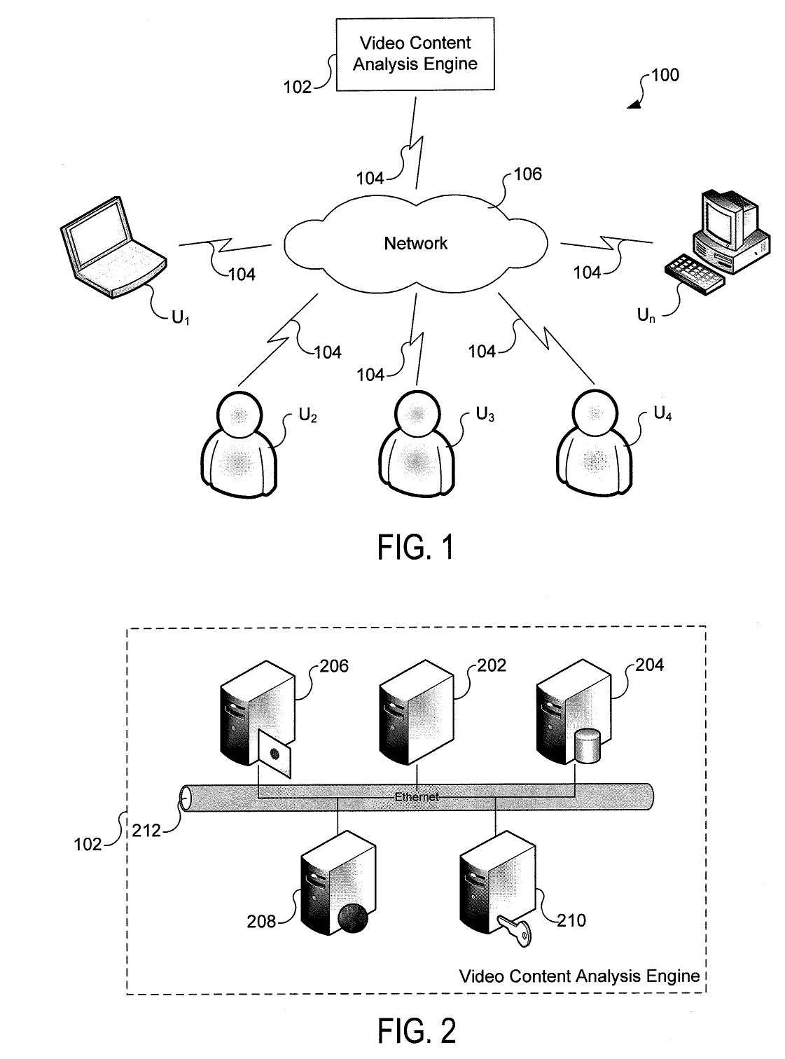

Referring now to the drawings, wherein like reference numerals and characters represent like or corresponding parts and steps throughout each of the many views, there is shown in FIG. 1 a learned cognitive system 100 according to a first embodiment of the present invention. Learned cognitive system 100 generally comprises a video content analysis engine 102, which is coupled by suitable means 104 through a network 106 to a plurality of users U₁, U₂, U₃, U₄, and Uₙ.

As noted herein above, and as illustrated in FIG. 1, each of the plurality of users U₁, U₂, U₃, U₄, and Uₙ may be a person (i.e., a human being) using a computer or other digital device, in a standalone environment or on the network; a client installed within a computer or digital device on the network, a server installed within a computer or digital device on the network, or a node installed within a computer or digital device on the network.

Moreover, network 106 may comprise a number of computers and associated devices that may be connected by communication facilities. It may also involve permanent connections such as cables or temporary connections such as those made through telephone or other communication links. Thus, network 106 may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network according to embodiments of the present invention may include: the Internet; an intranet; a local area network (LAN); a wide area network (WAN); and a combination of networks, such as an internet and an intranet. Exemplary networks may operate with any of a number of protocols, such as Internet protocol (IP), asynchronous transfer mode (ATM), and/or synchronous optical network (SONET), user datagram protocol (UDP), IEEE 802.x, etc.

As shown in FIG. 2, video content analysis engine 102 may comprise a plurality of servers 202, 204, 206, 208, and 210 coupled or connected to an Ethernet-based LAN. It may run, for example, on a simple server 202, or on a database server 204. More complex embodiments of the learned cognitive system 100 may further comprise a certificate server 206, web server 208, and public/private key server 210.

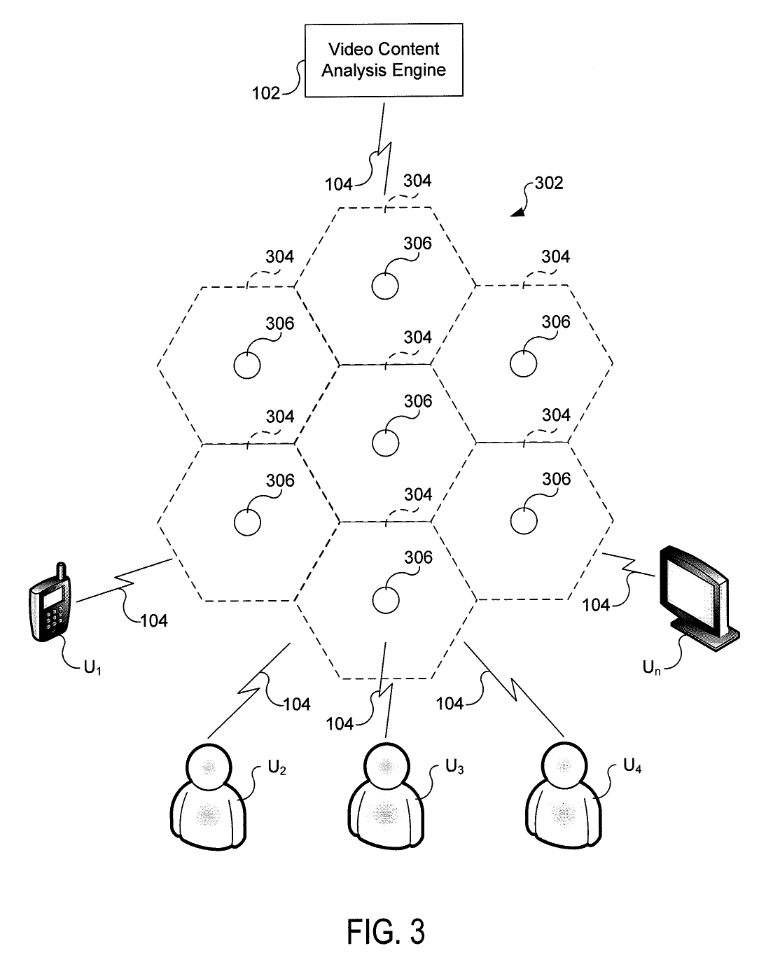

FIG. 3 illustrates another embodiment of the learned cognitive system 100 according to the present invention. In the embodiment shown in FIG. 3, the network may comprise a wireless network 302 (e.g., comprising a plurality of wireless access points or WAP 306), which allows wireless communication devices to connect to the wireless network 302 using Wi-Fi, Bluetooth or related standards. Each WAP 306 usually connects to a wired network, and can relay data between the wireless devices (such as computers or printers) and wired devices on the network.

Wireless network 302 may also comprise a wireless mesh network or WMN, which is a communications network made up of radio nodes organized in a mesh topology. Wireless mesh networks often consist of mesh clients, mesh routers, and gateways (not shown). The mesh clients are often laptops, cell phones and other wireless devices (see, e.g., U₁ and Uₙ), while the mesh routers forward traffic to and from the gateways which connect to the Internet. The coverage area of the radio nodes working as a single network is sometimes called a mesh cloud. Access to this mesh cloud is dependent on the radio nodes working in harmony with each other to create a radio network. A mesh network is reliable and offers redundancy. When one node can no longer operate, the rest of the nodes can still communicate with each other, directly or through one or more intermediate nodes. Wireless mesh networks can be implemented with various wireless technology including 802.11, 802.16, cellular technologies or combinations of more than one type.

A wireless mesh network can be seen as a special type of wireless ad hoc network. It is often assumed that all nodes in a wireless mesh network are static and do not experience mobility however this is not always the case. The mesh routers themselves may be static or have limited mobility. Often the mesh routers are not limited in terms of resources compared to other nodes in the network and thus can be exploited to perform more resource intensive functions. In this way, the wireless mesh network differs from an ad hoc network since all of these nodes are often constrained by resources.

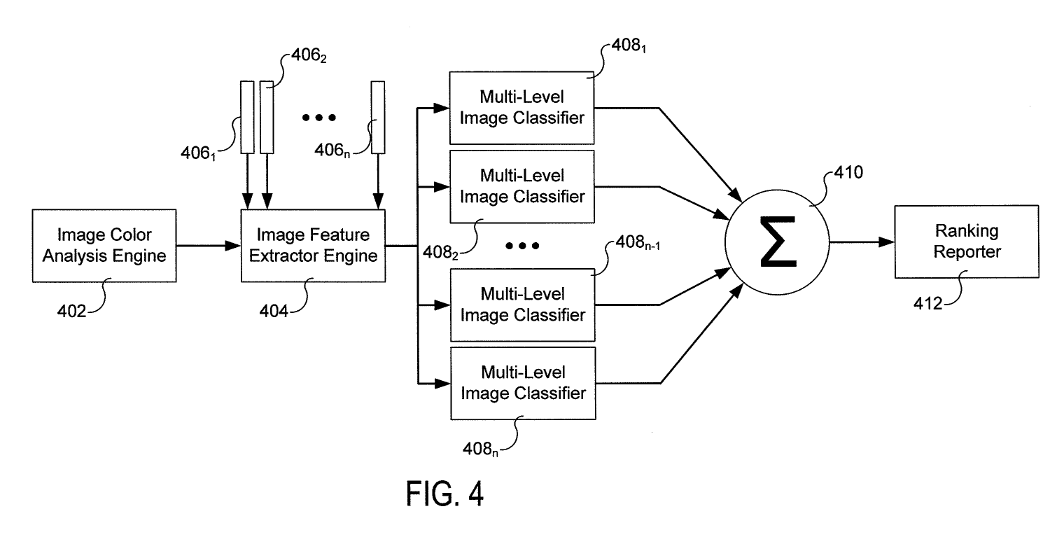

Referring now to FIG. 4, video content analysis engine 102 will now be further described. It should be understood that the method and utility of embodiments of the present invention applies equally to the detection and ranking of explicit video content on mass storage drives and video content which may be transmitted over any communications network, including cellular networks, and includes both single or still video content, and collections of video content used in motion pictures/video presentations.

Methods according to embodiments of the present invention start color detection in an image color analysis engine 402 by sampling pixels from the video content. The image color analysis engine 402 analyzes the color of each sampled pixel and creates a color histogram. The color histogram is used to determine the degree of human skin exposure. When a particular adjustable threshold is reached, an edge detection algorithm is activated that will produce a sort of line drawing. This edge detector is a first order detector that performs the equivalent of first and second order differentiation. The next phase of the process is local feature extraction in an image feature extraction engine 404, which is used to localize low-level features such as planar curvature, corners and patches. The edge detector identifies video content contrast, which represents differences in intensity and as result emphasizes the boundaries of features within the video content. The boundary of a specific object feature is a delta change in intensity levels and this edge is positioned at the delta change.

Embodiments of the present invention utilize active shape model algorithms to rapidly locate boundaries of objects of interest with similar shapes to those in a group of training sets. Active shape models allow defining, classify objects by shape/appearance and are particularly useful for defining shapes such as human organs, faces, etc. The accuracy to which active shape models can locate a boundary is constrained by the model. The model can deform in many ways and to which degree becomes is a function of the training set. The objects in an image can exhibit particular types of deformation as long as these are present in the training sets. This allows for maximum flexibility for search supporting both fine deformations as well as coarse ones. In order to locate a structure of interest, a model of it is built.

To build a statistical model of appearance requires a set of annotated images of typical examples. Then a decision is made on a suitable set of landmarks which describe the shape of the target and which can be found reliably on every training image. Choices for landmarks are points at clear corners of object boundaries, junctions between boundaries, or easily located biological landmarks. When there are rarely enough of such points to give more than a sparse description of the shape of the target object, this list augmented with points along boundaries which are arranged to be equally spaced between well defined landmark points. To represent the shape, the connectivity defining how the landmarks are joined to form the boundaries in the image are recorded which allows for determining the direction of the boundary at a given point.

Embodiments of the present invention utilize training sets of points x, which may be aligned into a common coordinate frame. These vectors form a distribution in the 2n dimensional space in which they live. These distributions can be modeled, new examples can be generated that will be similar to those in the original training sets and will allow for examine new shapes to decide whether they are plausible examples. For simplification, the dimensionality of the data is reduced from 2n to something more manageable and this may be done by applying principal component analysis or PCA to the data. The data form a cloud of points in the 2n-D space, though by aligning the points they are located in a (2n-4)-D manifold in this space. PCA computes the main axes of this cloud, allowing for the approximation of any of the original points using a model with less than 2n parameters. Further details regarding PCA may be found in Jackson, J. E., A User's Guide to Principal Components, John Wiley and Sons, 1991; and Jolliffe, I. T., Principal Component Analysis, 2nd edition, Springer, 2002, the contents of which are incorporated herein by reference.

Applying a PCA to the data allows for approximating any of the training set, x using x=x(the mean)+p(plplpl the eigenvectors of Co-Matrix I)*b. The vector b defines a set of parameters of a deformable model. By varying the elements of b this allows for varying the shape x. The eigenvectors, P, define a rotated co-ordinate frame, aligned with the cloud of original shape vectors. The vector b defines points in this rotated frame. The step in using PCA is to subtract the mean from each of the data dimensions. The mean subtracted is the average across each dimension. So, all the X values have the X(the mean) subtracted. The covariance matrix is square, so that the eigenvectors and eigenvalues can be calculated. This allows for determining whether the data has a strong pattern. The process of taking the eigenvectors of the covariance matrix allows for extracting lines that characterize the data. From the covariance matrix, resulting eigenvectors that are derived are perpendicular to each other.

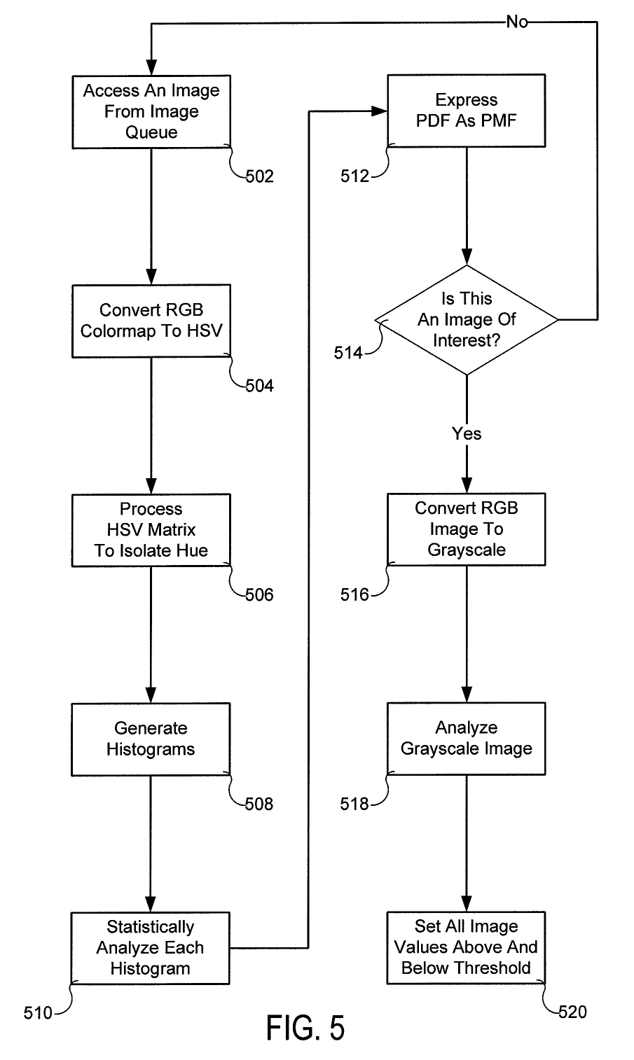

Referring now to FIG. 5 in conjunction with FIG. 4, there is shown a flowchart of a method according to embodiments of the present invention. At step 502, the video content analysis engine 102 accesses an image from an image queue. Any decodes/resizing which may be necessary for conversion of an RGB (“red-green-blue”) colormap to an HSV (“hue-saturation-value”) colormap or RGB2HSV processing at step 504 may then be done.

For example, MATLAB function “rgb2hsv” converts an RGB colormap to an HSV colormap, using the following syntax:

cmap=rgb2hsv(M)

hsv_image=rgb2hsv(rgb_image)

cmap=rgb2hsv(M) converts an RGB colormap, M, to an HSV colormap, cmap. Both colormaps are m-by-3 matrices. The elements of both colormaps are in the range 0 to 1.

The columns of the input matrix, M, represent intensities of red, green, and blue, respectively. The columns of the output matrix, cmap, represent hue, saturation, and value, respectively.

hsv_image=rgb2hsv(rgb_image) converts the RGB image to the equivalent HSV image. RGB is an m-by-n-by-3 image array whose three planes contain the red, green, and blue components for the image. HSV is returned as an m-by-n-by-3 image array whose three planes contain the hue, saturation, and value components for the image.

The colormap is an M (i.e., the number of pixels in the image)-by-3 matrix. The elements in the colormap have values in the range 0 to 1. The columns of the HSV matrix HSV(r, c) represent hue, saturation, and value.

The HSV matrix is processed at step 506 to isolate the H into a new matrix H(r, c)=HSV(r, c, 1). Each generated H(r, c) is histogram analyzed for hue (H) cluster identification. This is done by analyzing each column with a window size of one and creating a histogram at step 508 for each.

At step 510, each histogram is statistically analyzed against a pre-defined color palette, and those columns above a pre-set scoring threshold are marked. The histograms are probability mass functions (PMF), where any PMF can be expressed at step 512 as a probability density function (PDF) pₓ using the relation:

$${\sum }_{a} {p}_{x} ( a ) ( δ {x}_{0} - a )$$

All of the PDF results are then weight averaged and threshold filtered at step 514 to determine if this is an image of interest. If “yes”, the RGB image is converted to grayscale at step 516, while eliminating the hue and saturation information and retaining the luminance. If “no”, return to step 502 to access the next image in the image queue.

At step 518, the grayscale image is then analyzed, areas where values are mapped to a fairly narrow range of grays, create a more rapid change in grays around the area of interest by compressing the grayscale so it ramps from white to black more rapidly about the existing gray scale values.

Finally, at step 520, all image values below a pre-defined threshold are set to black, while the values from that threshold to 255 are represented by 8-16 different hues, ranging across the full color spectrum.

The system, method, and computer-program product described herein, thus, discloses a means for classification and rating of explicit images/videos or “video content” comprising an access method for transferring images/videos from mass storage devices and network infrastructures; an engine system for automatically analyzing video content for explicit content using multiple colorization, feature extractor and classification/rating engines; and an output reporting engine 412 that interfaces to the engine system to convey the results of the analysis of the video content which lists the content ratings and the associated video content filename.

Such a system, method, and computer-program product may suitably rate and classify video content using histogram color analysis on human skin color. They may use feature extraction analysis. Moreover, they may use learned semantic rules and data structures 406₁ through 406ₙ which may be used to input trained classifier analyzers, including trained multiple levels of classifier analyzers 408₁ through 408ₙ. Such analyzers may, in turn, rate and classify video content using active shape models to locate objects of interest with similar shapes to those in a group of training sets.

Systems, methods, and computer-program products according to embodiments of the present invention may suitably comprise analyzers which rate and classify video content using active shape models to define and classify objects such as human organs, faces, etc. by shape and/or appearance. They may further comprise vector machines which contain learning algorithms that depend on the video content data representation. This data representation may implicitly be chosen through the a kernel K{x, x′} which defines the similarity between x and x′, while defining an appropriate regularization term for learning.

In such circumstances, the vector machines may use {xi, yi} as a learning set. Here, xi belongs to the input space X and yi is the target value for pattern xi. The following f(x) Sum(a*K(x, x′))+b is solved where a, b are coefficients to be learned from training sets and K(x, x′) is a kernel Hilbert space.

Finally, systems, methods, and computer-program products according to embodiments of the present invention may suitably uses multiple support vector machines and, therefore, multiple kernels to enhance the interpretation of the decision functions and improve performances. In this case, the kernel K(x, x′) is a convex combination of basis kernels. This would be K(x, x′)=Sum(d*k(x, x′)) and where each basis kernel k may either use the full set of variables describing x or subsets of variables stemming from different data sources.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A learned cognitive system, comprising:
means for transferring video content from mass storage devices and network infrastructures;
an engine for automatically analyzing video content for explicit content using multiple colorization, feature extractor and classification/rating engines; and
an output reporting engine that interfaces with the engine to convey the results of the analysis of the video content which lists the content ratings and the associated video content filename.

2. The system according to claim 1, wherein said analysis rates and classifies video content using histogram color analysis on human skin color.

3. The system according to claim 1, wherein said analysis rates and classifies video content using feature extraction analysis.

4. The system according to claim 1, wherein said analysis rates and classifies video content using trained classifier analyzers.

5. The system according to claim 1, wherein said analysis rates and classifies video content using trained multiple levels of classifier analyzers.

6. The system according to claim 1, wherein said analysis rates and classifies video content using active shape models to locate objects of interest with similar shapes to those in a group of training sets.

7. The system according to claim 1, wherein said analysis rates and classifies video content using active shape models to define and classify objects by shape and/or appearance.

8. The system according to claim 1, wherein said analysis rates and classifies video content using support vector machines which contain learning algorithms that depend on the video content data representation.

9. The system according to claim 8, wherein said data representation is selected through a kernel K{x, x′} which defines the similarity between x and x′, while defining an appropriate regularization term for learning.

10. The system according to claim 8, wherein said analysis rates and classifies video content using support vector machines where {xi, yi} is used as a learning set.

11. The system according to claim 10, wherein xi belongs to the input space X and yi is the target value for pattern xi.

12. The system according to claim 11, wherein the function Sum(a*K(x, x′))+b is solved, where a, b are coefficients to be learned from training sets, and K(x, x′) is a kernel Hilbert space.

13. The system according to claim 8, wherein said analysis rates and classifies video content using multiple support vector machines and multiple kernels to enhance the interpretation of the decision functions and improve performances.

14. The system according to claim 13, wherein the kernel K(x, x′) is a convex combination of basis kernels.

15. The system according to claim 14, wherein K(x, x′)=Sum(d*k(x, x′)), and wherein each basis kernel k may either use the full set of variables describing x or subsets of variables stemming from different data sources.
